(19) United States
(12) Patent Application Publication
(10) Pub. No.: US 2005/0112959 A1
(43) Pub. Date: May 26, 2005

(54) Large elastic momentum conduction member of IC device socket

(76) Inventor: Kuang-Chih Lai, Tu-Cheng City (TW)

Correspondence Address: TROXELL LAW OFFICE PLLC, 5205 LEESBURG PIKE,, SUITE 1404, FALLS CHURCH, VA, 22041, US

(21) Appl. No.: 10/716,554

(22) Filed: Nov. 20, 2003

(51) Int. Cl. H01R 4/48

(52) U.S. Cl. 439/862

(57) ABSTRACT

A large elastic conduction member of an IC device socket, including a middle part imbedded in an insertion hole of an insulation plate of the IC device socket; a first elastic part and a second elastic part respectively extending from a first end and a second end of the middle part; both elastic parts extending laterally at a certain inclination or curvature with each of their length projected on the insulation plate greater than the spacing between any two abutted terminals of the IC device socket to allow longer elastic part, larger elastic movement, and lowered height without being restricted by the minimum spacing to allow a contactor of the elastic part to make at least one point of strong effect contact of elastic compression with the IC device or a circuit board.

### BACKGROUND OF THE INVENTION

1. Field of the Invention

The present invention is related to an IC device socket, and more particularly to a large elastic momentum conduction member of IC socket.

2. Description of the Prior Art

Generally the structure of a terminal of an IC device, particularly a central process unit (CPU), may be classified into three types of arrays, respectively the Pin Grid Array (P.G.A.), the Ball Grid Array (B.G.A.) and the Land Grid Array (L.G.A.).

As taught in U.S. Pat. No. 5,456,613, a socket specific for the P.G.A. IC device is provided. However, the socket is very thick and fails to meet the requirement of being compact since the P.G.A. type of IC device is disposed of an extremely long terminal, and it takes a conduction member with a compatible height to be embedded in the thick insulation plate for it to contact the terminal of the IC device and the conduction contact of the PCB.

Later the B.G.A. type of IC device has a reduced length since the terminal has been developed by changing the pin terminal of the P.G.A. type of IC device into a ball grid, e.g., tin ball or copper ball, such as the socket specific to the B.G.A. type of IC device disclosed in U.S. Pat. No. 5,419,710.

The latest development of the L.G.A. type of IC device in flat land grid array allows a less complicated structure, lower production cost and better conduction results, such as those taught in U.S. Pat. Nos. 5,192,213; 5,199,889; 5,320,550; and 5,362,241 to provide many types of sockets in different structures.

To reduce the size of the IC device, the spacing between any two abutted contact terminals must be made narrower and denser, such as 1.27, 1.0, 0.8 and 0.5 m is generally provided. Within such a small space, it is already very difficult to insert a conduction member. Since sufficient space for up and down elastic momentum of the conduction member is required, the retractable elastic part of the conduction member is permitted only to extend in the direction at right angle to the conduction terminal of the IC device, resulting in an extremely large thickness of the existing socket. Furthermore, the structure for the elastic part extending toward the conduction terminal of the IC device at a right angle not only requires an even more complicate structure, but also fails to provide sufficient space for the up and down elastic momentum.

### SUMMARY OF THE INVENTION

The primary purpose of the present invention is to provide a large elastic conduction member of IC socket to achieve the following purposes:
1. At least one contactor having reliable contact with a conduction terminal of the IC device shall be provided with a first elastic part of the conduction member of the present invention.
2. At least one contactor having reliable contact with a conduction terminal of the IC device shall be provided with a second elastic part of the conduction member of the present invention.
3. Furthermore, a middle part of the conduction member of the present invention can be embedded into an insulation plate.

To achieve these purposes, the elastic part of the large elastic momentum conduction member of an IC device socket of the present invention is extended from the middle part at a certain inclination or curvature; and when the conduction member is compressed by the IC device to its final contact location, the length of the elastic part projected to the insulation plate becomes greater than the spacing of any two abutted terminals. Consequently, the elastic part is not subject to the smaller spacing as described above and becomes longer, providing a elastic movement and consumes less space in it height for better contact results.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become obvious to those vested in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a first preferred embodiment of a conduction member of the present invention.

FIG. 2 is a perspective view of a second preferred embodiment of a conduction member of the present invention.

FIG. 3 is a perspective view of a third preferred embodiment of a conduction member of the present invention.

FIG. 4 is a perspective view of a fourth preferred embodiment of a conduction member of the present invention.

FIG. 5 is a perspective view of a fifth preferred embodiment of a conduction member of the present invention.

FIG. 6 is a sectional view showing that the first preferred embodiment of the conduction member of the present invention is embedded in an insertion hole of an insulation plate.

FIG. 7 is a sectional view showing that the second preferred embodiment of the conduction member of the present invention is embedded in an insertion hole of an insulation plate before the IC device has not yet been pressed down.

FIG. 8 is a sectional view showing that the second preferred embodiment of the conduction member of the present invention is embedded in an insertion hole of an insulation plate after the IC device has been pressed down.

FIG. 9 is a sectional view showing that the third preferred embodiment of the conduction member of the present invention is embedded in an insertion hole of an insulation plate before the IC device and the insulation plate have not yet been pressed down.

FIG. 10 is a sectional view showing that the third preferred embodiment of the conduction member of the present invention is embedded in an insertion hole of an insulation plate before the IC device and the insulation plate has not yet been pressed down but the insulation plate has been pressed down.

FIG. 11 is a sectional view showing that the third preferred embodiment of the conduction member of the present invention is embedded in an insertion hole of an insulation plate after both the IC device and the insulation plate have been pressed down.

### DETAILED DESCRIPTION OF THE PREFERRED EMBODIMENTS

The following descriptions are for exemplary embodiments only, and are not intended to limit the space, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

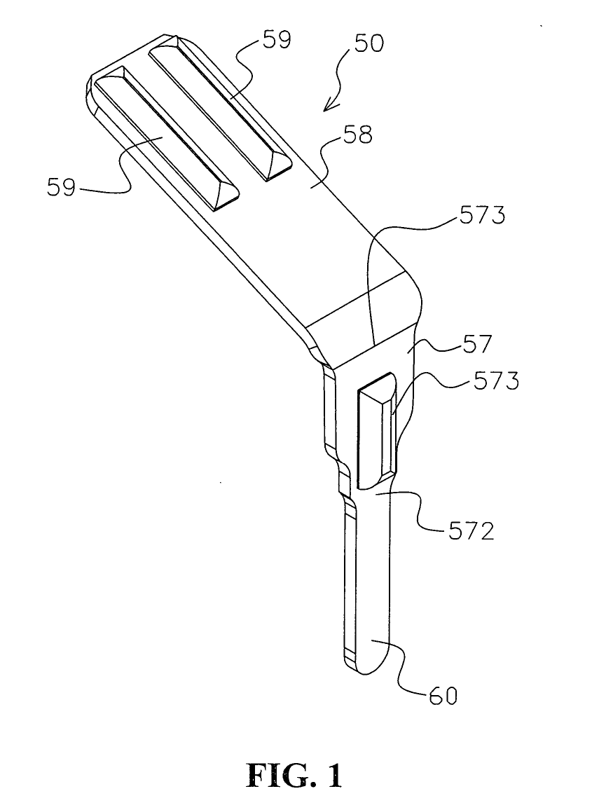

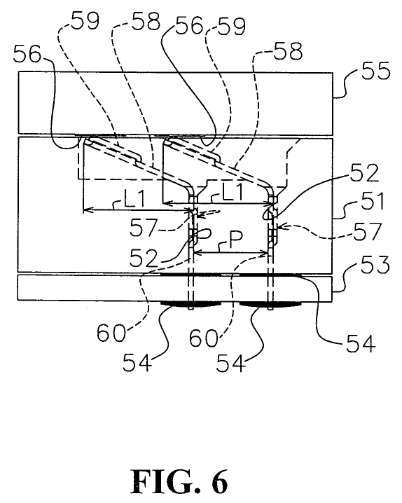

Referring to FIGS. 1 and 6 for a first preferred embodiment of a conduction member 50 of the present invention, multiple large elastic conduction members 50 are each embedded one by one into an insertion hole 52 of an insulation plate 51 to respectively contact multiple corresponding contacts 54 provided on a circuit board 53, and multiple terminals 56 disposed on an IC device 55 so as to form a connection between the conduction contact 54 and the terminal 56.

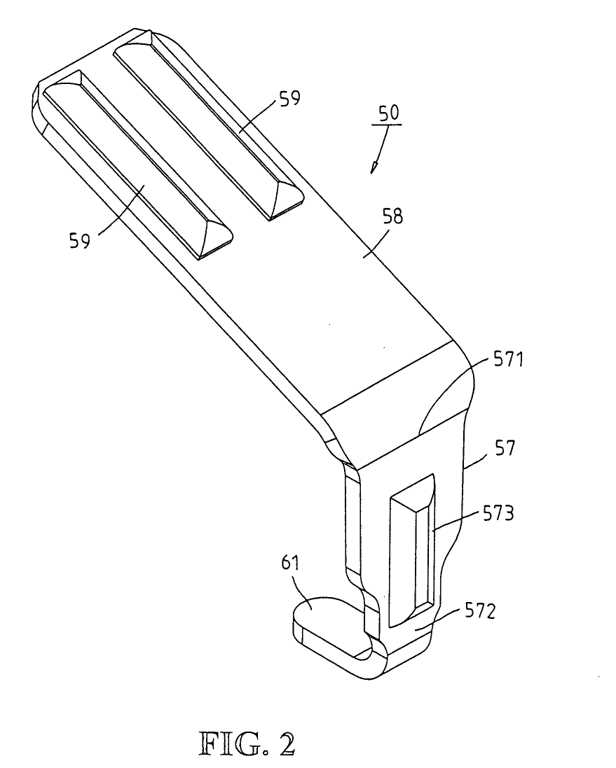

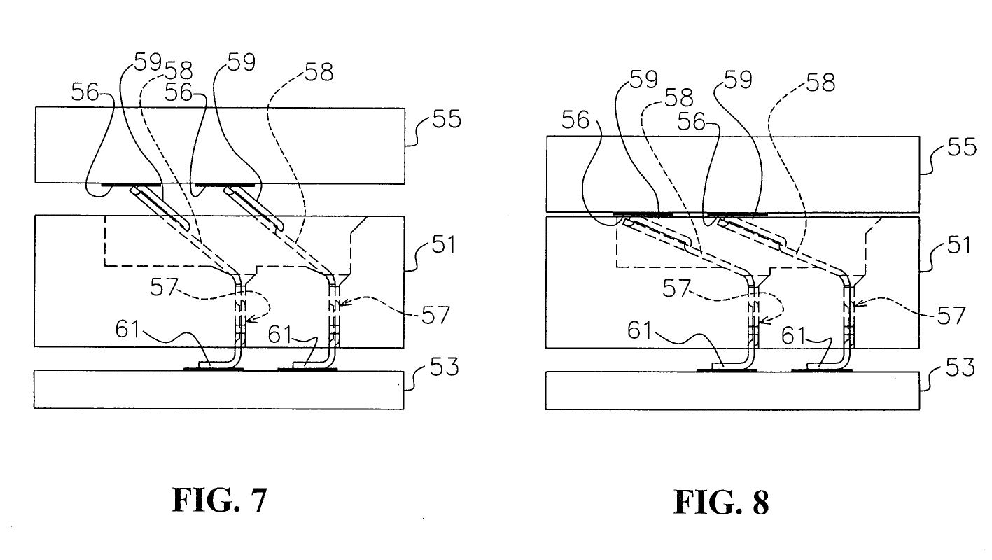

The conduction member 50 includes a middle part 57, a first elastic part 58, multiple first contactors 59 (two in the first preferred embodiment), and a second contactor 60. Wherein, the middle part 57 is provided with a first end 571 and a second end 572; the middle part 57 is embedded into the insertion hole 52 of the insulation plate 51. The first elastic part 58 laterally extends at a certain inclination or curvature from the first end 571 of the middle part 57. When the conduction member 50 is subject to the compression by the IC device 55 to a final contact position, a length (L1) projected by the first elastic part 58 on the insulation plate 51 becomes greater than a spacing P between any two abutted terminals 56 of the IC device 55. A first contactor 59 is integrally made with a free end of the elastic part 58 so as to slide and contact the terminal 56 when the terminal 56 is pressed. The second contactor 60 is integrally made with and extends downwardly from the second end 572, or as illustrated in FIGS. 2, 7 and 8, is further folded so to contact with multiple contacts 54 disposed on the insulation plate 53. Furthermore, a protrusion 573 may be provided on a local position to facilitate embedding the middle part 57 into the insertion hole 52.

As illustrated in FIG. 1, two first contactors 59 protrude from the surface of the first elastic part 58 with the tops of both contactors 59 contacting two different parts of the terminal 56 of the IC device.

In a second preferred embodiment of the conduction member 50 of the present invention as illustrated in FIGS. 2, 7, and 8, a soldering part 61 is integrally made with and extends from the second end 572. As illustrated, the soldering part 61 may extend in a same direction of or in an opposite direction to the first elastic part 58 to be soldered to the insulation plate 53. Other than the soldering part 61, the remaining structure of the second preferred embodiment is exactly the same as that of the first preferred embodiment.

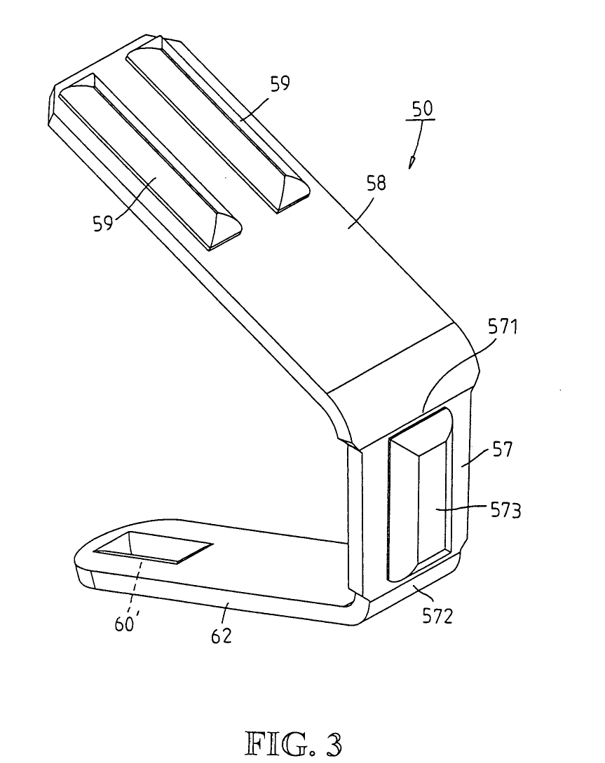

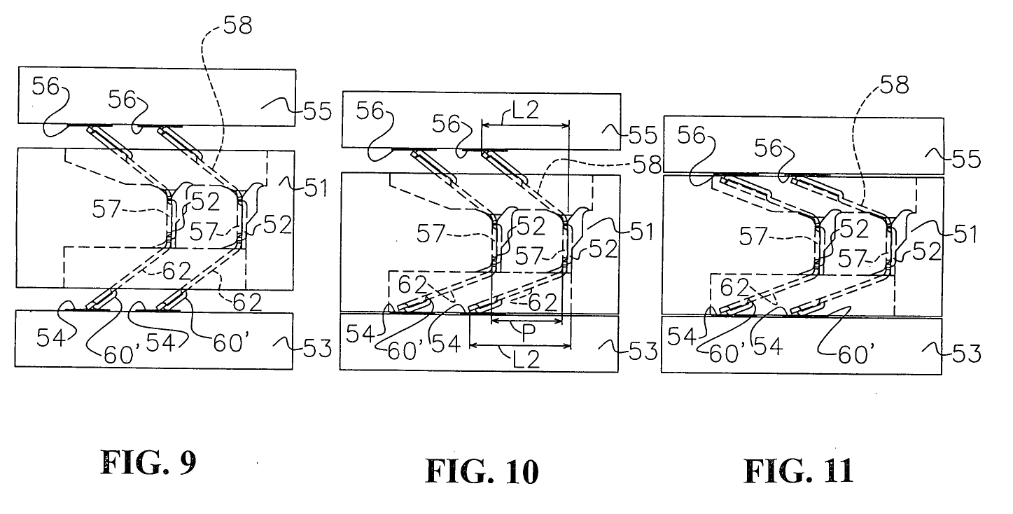

FIGS. 3, 9, 10, 11 show a third preferred embodiment of the conduction member 50 of the present invention. Wherein the conduction member 50 further includes a second elastic part 62 and a second contactor 60′. The second elastic part 62 is made integrated with and laterally extended form the second end 572 at a certain inclination or curvature. Once the conduction member 50 for being compressed by the IC device 55 to the final contact position, a length (L2) projected by the second elastic part 62 on the insulation plate 51 is greater than the spacing P between any two abutted terminals 56 of the IC device 55. The contactor 60′ is made integrated with on the distal end on the surface of the second elastic part 62 to facilitate sliding and contacting with the conduction contact 54. Other than the second elastic part 62 and the second contact 60′, the remaining structure of the third preferred embodiment is exactly the same as that of the first preferred embodiment.

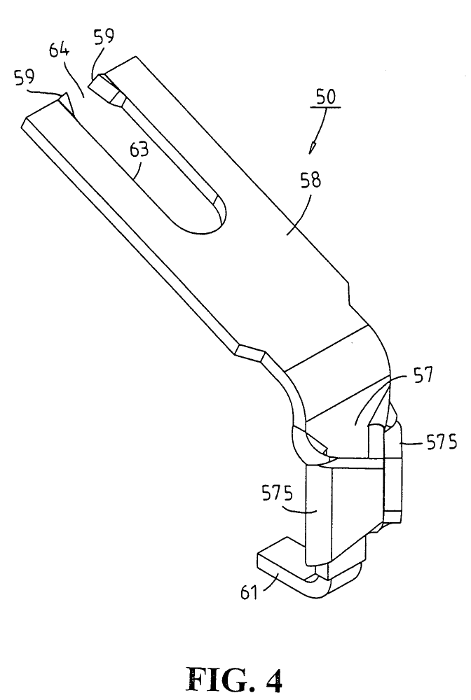

Now referring to FIG. 4 a fourth preferred embodiment of the conduction member 50 of the present invention, two flaps 575 folded in the direction facing away from the first elastic part 58 are extended from both sides of the middle part 57; and both flaps 575 are made facing each other to facilitate the force applied by jigs to secure the middle part 57 in the insertion hole 52. Furthermore, a slot 63 is provided on the first elastic part 58 and connected through its free end to allow the slot 63 to form an opening 64 at the free end of the first elastic part 58. Two first contactors 59 are respectively provided on and protruded from both inner edges of the opening 64 to contact two different positions on the terminal of the IC device. The fourth preferred embodiment of the conduction member 50 of the present invention is also disposed with a soldering part 61.

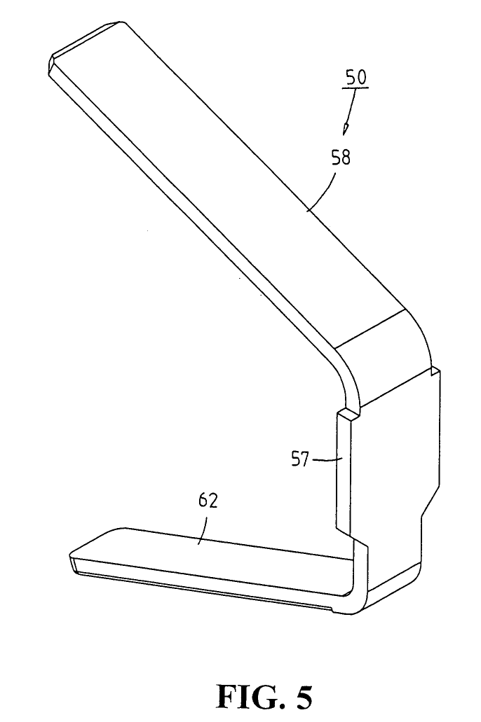

In a fifth preferred embodiment of the conduction member 50 of the present invention as illustrated in FIG. 5, all the middle part 57, the first elastic part 58 and the second elastic part 62 are each made in a flat plate structure.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-9. (canceled)

10. An elastic conduction member of an isolation plate electrically connecting an IC device and a circuit board comprising:
a plurality of conduction members, each of the plurality of conduction members having:
a) a first elastic part having two first protrusions being spaced apart, each of the two first protrusions being spaced apart from opposing outer edges of the first elastic part;
b) a second elastic part; and
c) a middle part connected between the first elastic part and the second elastic part,
wherein the middle part is inserted into an insertion hole of an isolation plate, each of the two first protrusions of the first elastic part engaging a terminal of the IC device and the second elastic part engaging a contact of the circuit board.

11. The according to claim 10, wherein the first elastic part of each of the plurality of conduction members projects a length on the isolation plate that is greater than a distance between the middle part of two adjacent conduction members of the plurality of conduction members.

12. The according to claim 10, wherein each of the two first protrusions extend upwardly from a top surface of the first elastic part.

13. The according to claim 10, wherein the first elastic part includes a slot, the two first protrusions protrude inwardly and are located on opposing inner edges of the slot on an end of the first elastic part opposite the middle part.

14. The according to claim 10, wherein the second elastic part is bent at a predetermined angle relative to the middle part.

15. The according to claim 14, wherein the second elastic part of each of the plurality of conduction members projects a length on the isolation plate that is greater than a distance between the middle part of two adjacent conduction members of the plurality of conduction members.

16. The according to claim 10, wherein the second elastic part includes a soldering part.

17. The according to claim 10, wherein the second elastic part includes a second contact.

18. The according to claim 10, wherein the middle part includes a second protrusion extending outwardly from a surface thereof.

19. The according to claim 18, wherein the second protrusion includes first and second flaps located on opposing edges the surface of the middle part, the first flap extending toward the second flap.
